(19) United States
(12) Patent Application Publication
(10) Pub. No.: US 2002/0091558 A1
(43) Pub. Date: Jul. 11, 2002

(54) System and method for determining and implementing best practice in a distributed workforce

(76) Inventors: Thomas N. Anderson, Sherborn, MA (US); Andreas Beroutsos, New York, NY (US); Kevin Bradicich, Riverside, CT (US); Nathaniel Whitman Foote, Newton, MA (US); Jonathan B. Harris, New York, NY (US); Brian G. Hanessian, Chicago, IL (US); Quentin Hope, Denver, CO (US); Brian G. Kanner, Kemebunkport, ME (US); David Krawitz, Elizabeth Bay (AU); John Lucas, Evanston, IL (US); Simon Mendelson, New York, NY (US); Michael S. Pritula, Scarsdale, NY (US); Nicholas Rudd, New York, NY (US); Nancy Thurmon Schmitt, New York, NY (US); Ellen Wilson Shumway, Chicago, IL (US); Laurence Piers Smith, Natick, MA (US); Nancy Gail Taubenslag, Scarsdale, NY (US); John Adams Wilcox, New York, NY (US); Kristina Maria Wollschlaeger, Brooklyn, NY (US); William B. Joiner, Concord, MA (US)

Correspondence Address: COVINGTON & BURLING, ATTN: PATENT DOCKETING, 1201 PENNSYLVANIA AVENUE, N.W., WASHINGTON, DC, 20004-2401, US

(21) Appl. No.: 09/757,700

(22) Filed: Jan. 11, 2001

(51) Int. Cl. G06F 17/60

(52) U.S. Cl. 705/9; 705/7; 705/10

(57) ABSTRACT

The present invention provides a system and method for determining, distributing and implementing the best practice for performing a task, and for assessing deviations from that best practice. A feature of the invention involves the identification of qualified reviewers from among workers who perform the task, in order to facilitate and expedite assessment of other workers' performance of the task, and to help prompt interest by other workers in learning and implementing the best practice. Other features include rapid identification of best practices, which enables organizations to adapt their best practices as changes occur in the industry and in customer expectations. The systems and methods of the present invention are especially useful in the context of organizations, such as insurance companies, whose workforces may be distributed over a number of offices.

### FIELD OF INVENTION

The present invention relates to the field of best practice development and implementation. More particularly, the present invention relates to a system and method for determining, disseminating and implementing the best practice for workers to perform a task in a given industry, and for assessing deviations from best practice. In preferred embodiments, the present invention relates to a system and method for determining, disseminating and implementing the best underwriting and claims processing practices in the field of insurance, and for assessing deviations from those best practices.

### BACKGROUND

In the past, insurance companies conducted internal audits of underwriting or claims processing practices of field representatives on an ad hoc and frequently inconsistent basis. Different field offices were often evaluated under different standards. This often resulted in analyses of organizational procedures that were poor and of limited utility. In addition, inefficient and inconsistent standards for review continued to propagate throughout the field offices.

Past efforts to improve the conduct of internal audits in the insurance industry have involved procedures for standardizing the audits in order to improve quality control. These procedures included the assignment of a small group of “experts,” which typically included supervisors, office managers, other executives, and, on occasion, field representatives they selected, to review sample files (sometimes numbering in the hundreds) at each field office. The experts were usually chosen based on their experience and typically were highly rated and respected by their managers. This “Core Team” preferably included members from different offices and geographic regions as well as from different levels in the organization, in order to assure representation of different practices and views across the organization.

In current practice, an audit process usually begins with the formulation by the Core Team of a list of issues and questions that usually must be addressed whenever a field representative processes a claim, analyzes a new policy or performs another task. If the focus is on claims processing, for example, the Core Team members typically first interview file handlers, claim managers, and other personnel of the field offices they are auditing in order to determine how the claims handling process in fact works in those offices, and to develop at least preliminary ideas about opportunities for improvement. The Core Team then selects and analyzes a small number of case files that are expected to typify the issues that arise during the ordinary course of a field representative's contact with insurance customers. A goal is to select these cases so that they encompass a full range of issues on how claims were handled by the particular field office.

Typically, an audit then proceeds by having Core Team team members collectively analyze a few representative case files before the start of an actual audit effort. This analysis also develops a first draft of a questionnaire to be used as a roadmap of issues for analyzing the files to be audited. The Core Team also discusses difficult questions or fact situations in order to formulate proposed uniform responses to the questionnaire. The Core Team may also calibrate the questionnaire by evaluating additional claims files and developing the “correct” or preferred answers. Poorly worded questions are eliminated, and questions that can result in more than one “correct” answer are amended. A goal is to develop a set of questions and preferred responses so that individual Core Team members will be likely to evaluate particular cases in a similar manner. The number of additional claims files analyzed during this process depends on a variety of factors, including how long it takes for the questionnaire to stabilize, when the questions no longer have to be amended to remove ambiguities, and the nature and complexity of unanticipated issues. This process of developing a questionnaire typically takes an experienced Core Team a minimum of three to four weeks to complete.

In current practices, after the questionnaire is complete, the actual audit of field offices may begin, and the Core Team, as a group, considers the issues presented in the questions that they have created when they review individual case files. This is known as a Closed File Review (“CFR”). Because individual claim representatives may have varying understandings of the questions, the Core Team may continue to determine the “correct” or preferred answers to the questionnaire even as the audit review of individual cases files is underway. For each case file, after its CFR is complete, the Core Team then compares the “correct” response to the actions actually taken by the field representative working the case.

For the first few days of the actual CFR, the team may “double review” case files and discuss discrepancies in their answers. Random files may be selected and reviewed by the team, and according to past experience, approximately 100-125 case files should be reviewed for each field office of a typical insurance organization both to obtain an adequate sampling of the practices of a field office and to facilitate comparison of practices by different offices. It usually takes approximately two to three months to perform a CFR for a typical insurance field office.

After reviewing an appropriate number—perhaps hundreds—of case files from a field office, a Core Team should be able to identify the problem areas for the representatives in that office and to make general recommendations for improvements in that office. The Core Team typically does this by preliminarily identifying problem areas and improvement opportunities, and conducting a number of qualitative interviews of office personnel in order to confirm the CFR findings. This process of analyzing the CFR findings and developing recommendations for improved efficiency and cost control typically takes approximately an additional month.

This entire CFR process may then be repeated in the other field offices in order to develop recommendations for improvements in those offices and to form a basis for comparison across offices.

It should be apparent that, under current practice, a meaningful CFR can be labor-intensive and can frequently require a relatively long period of time to complete. Moreover, when the best field representatives are selected to participate in a CFR as members of the Core Team, they are taken away from their jobs, and what they do best, in order to participate in a CFR process. Furthermore, over time, but before a CFR audit can be completed for a large portion of an entire organization, the audit methodology and personnel may change. Such changes increase the risk of a lack of uniformity and consistency, thereby jeopardizing primary goals of the auditing process. In addition, it is generally not easy to distribute and transform the knowledge and expertise developed by the members of the Core Team into a tool for training field representatives or other employees.

The CFR audit methodology described above can be applied to other industries. However, as a corollary, the problems with the CFR process described above are likely to appear when the methodology is adapted to other fields.

For the foregoing and other reasons, there is a need for an improved method for determining best practices within an organization or an industry that is cost-effective and efficient and that better incorporates, in an iterative process, the experience of a broader set of individuals who perform a task so as to leverage the expertise that is already existing, but may be latent, within the organization. The new method should also be less labor-intensive than previous procedures, such as CFR, and should provide an opportunity to implement the best practices by incorporating an interesting program for training a distributed workforce.

### SUMMARY OF THE INVENTION

The present invention is directed to methods and systems for determining and disseminating a best practice for performing a task, assessing deviations from best practice, and training workers to implement best practice.

In one aspect, the present invention provides a method for assessing compliance with a best practice for performing a task. The method comprises the steps of: (a) identifying the best practice; (b) creating a test to measure consistency between the way individuals perform or should perform the task—known as individual-preferred-practice —and the best practice; (c) administering the test to a group of people who perform the task; (d) designating, in response to the testing, at least one member of the group as a qualified reviewer; (e) conducting a review of actual practices of other individuals who perform the task, with the review conducted by at least one qualified reviewer; and (f) analyzing the results of the review to assess the consistency of actual practices with the best practice.

In preferred embodiments, the qualified reviewers and the people who perform the task (and whose work is thus being “reviewed”) are from the same organization and, in further preferred embodiments, are peers. Thus, the method of the present invention provides a vehicle for workers to be designated as qualified reviewers, based for example on how well their individual-preferred-practice comports with the best practice, and then to be involved in assessing the work of their co-workers. In additional aspects of the invention, programs are formulated to train workers in the best practice, and test takers are given opportunities to get feedback on their test answers, and to review the rationale or reasons for the preferred answer or the best practice in a particular context. These steps are expected to provide both qualified reviewers and their co-workers with increased levels of interest in learning about and implementing the best practice.

Another aspect of the invention provides a method for determining the best practice for performing a task. This method comprises the steps of: (a) convening a group of experts in the performance of the task; (b) collaborating, among the experts, to develop a questionnaire concerning the performance of the task; (c) administering the questionnaire to a subset (or all) of the experts in a manner directed to at least one case study involving the task; (d) evaluating the questionnaire results, for example to assess whether the experts' responses reflect a consensus on how best to perform the task; and (e) in response to the evaluation, converging on the best practice, typically through additional collaboration among at least some of the experts.

In the insurance industry, for example, the methods of the present invention are expected to improve conventional Closed File Review processes. For example, a small group of experts can develop or identify a best practice, a potentially large number of qualified reviewers can be identified, and an actual review of current individual-preferred-practices can thus be conducted very quickly. Moreover, unlike conventional file review processes, many of the steps of the methods of the present invention can be implemented using computer systems and electronic telecommunications networks. For example, collaborations among experts or workers can take place using well-known electronic collaboration techniques, and tests can be administered via the Internet or local area or wide area networks. Thus, review of files or of individual-preferred-practices can commence quickly, and can be conducted at field offices by qualified reviewers who regularly work at those field offices and who are thus familiar with and to other workers at those offices. In this way, interest by all workers in learning about and implementing the best practice can be heightened.

As used in this specification, the phrase “perform a task” encompasses the full range of mental and physical activities involved in the industry. For example, in the insurance industry, performing a task can include soliciting a customer, making a presentation, completing an application, evaluating an application or a claim, processing a claim, and deciding how much to pay on a claim.

In another aspect, the method of the present invention includes the steps of: (a) defining a provisional-best-practice for performing the task based on collaboration among a designated team; (b) creating a test for determining individual-preferred-practices for performing the task, with test questions and an answer corresponding to each test question; (c) administering the test to people who perform the task (but who may not be members of the team that defined the provisional-best-practice); (d) determining, for each test taker, a test score representing a degree of consistency between individual-preferred-practice and the provisional-best-practice; (e) identifying each test question for which the corresponding answer disagrees with the answers to that question provided by a predetermined proportion of the test takers whose test scores represent at least a selected degree of consistency between individual-preferred-practice and the provisional-best-practice; and (f) deciding, responsive to the identifying step, whether the provisional-best-practice can be designated as the best practice for performing the task. In preferred embodiments, the steps of the method of the invention, including for example the administering step, can be implemented using a network, such as a telecommunications network like the Internet or a local or wide area computer-communications network.

In another aspect, the present invention provides a method for testing individuals who perform a task to measure the consistency between the way they perform the task, known as individual-preferred-practice, with a best practice for performing the task. This method includes the steps of: (a) creating a test for determining individual-preferred-practice for performing the task, with the test questions and corresponding answers; (b) administering the test to people who perform the task; (c) determining for each of the test takers a test score representing a degree of consistency between individual-preferred-practice and the best practice; (d) identifying each test question for which the corresponding answer disagrees with answers to that question provided by a predetermined proportion of test takers whose test scores represent at least a selected degree of consistency between individual-preferred-practice and the best practice; and (e) modifying the test responsive to the identifying step. In preferred embodiments, the steps of the method of the invention, including for example the administering step, can also be implemented using a network, such as a telecommunications network like the Internet or a local or wide area computer communications network.

In a more general aspect, the present invention provides a method for distributed calibration of a test. This method comprises the steps of: (a) creating a test with at least one test question and a provisional-best-answer corresponding to each test question; (b) administering the test to a plurality of test takers; (c) determining for each test taker a test score representing a degree of consistency between provisional-best-answers and test-taker-answers; (d) identifying each test question for which the provisional-best-answer disagrees with the test-taker-answers provided by a predetermined proportion of test takers whose test scores represent at least a selected degree of consistency between provisional-best-answers and test-taker-answers; and (e) deciding, responsive to the identifying step, whether the provisional-best-answers can be designated as best answers. Various steps of this method can as well be implemented over a network such as the Internet or a local or wide area computer communications network.

The present invention advantageously provides a method for assessing whether actual practices for performing a task within an office, organization or industry comport with best practice for performing that task.

The present invention also advantageously provides a method and system for determining the best practices within an organization or an industry that is cost-effective and efficient.

It is another advantage of the present invention to facilitate the use of peers or co-workers as qualified reviewers of actual practices of other workers.

It is a further advantage of the present invention to facilitate the use of peers or co-workers to train other workers in a best practice for performing a task.

It is yet another advantage of the present invention to provide a method that can be implemented over the Internet or other electronic telecommunications system for identifying and disseminating a best practice.

It is a further advantage of the present invention to reduce the time for developing and assessing compliance with best practice, thereby permitting organizations more efficiently to identify and address areas and practices needing improvement.

It is still another advantage of the present invention to provide a method that can be implemented over the Internet or other electronic telecommunications system for training representatives or other employees, including widely distributed employees, in a best practice.

These and other features and advantages of the invention will be more fully understood from the following detailed description of preferred embodiments that should be read in light of the accompanying drawings.

### BRIEF DESCRIPTION OF THE DRAWINGS

The accompanying drawings, which are incorporated in and form a part of the specification, illustrate a preferred embodiment of the present invention and, together with the description, serve to explain the principles of the invention.

FIG. 1 depicts a flow diagram of a preferred embodiment of a method of the present invention for assessing compliance with a best practice.

FIG. 2 depicts a flow diagram of a preferred embodiment of a method of the present invention for identifying a best practice.

FIG. 3 illustrates a flow diagram of a process of a preferred embodiment of the present invention;

FIG. 4 illustrates an embodiment of a program for formulating a questionnaire of a preferred embodiment of the present invention;

FIG. 5 illustrates an embodiment of a program for answering the questionnaire of a preferred embodiment of the present invention;

FIG. 6 illustrates an embodiment of a report of the present invention; and

FIG. 7 illustrates an embodiment of a program for reviewing questionnaire answers and rationale.

### DETAILED DESCRIPTION

In describing a preferred embodiment of the invention, specific terminology will be used for the sake of clarity. However, the invention is not intended to be limited to the specific terms so selected, and it is to be understood that each specific term includes all equivalents.

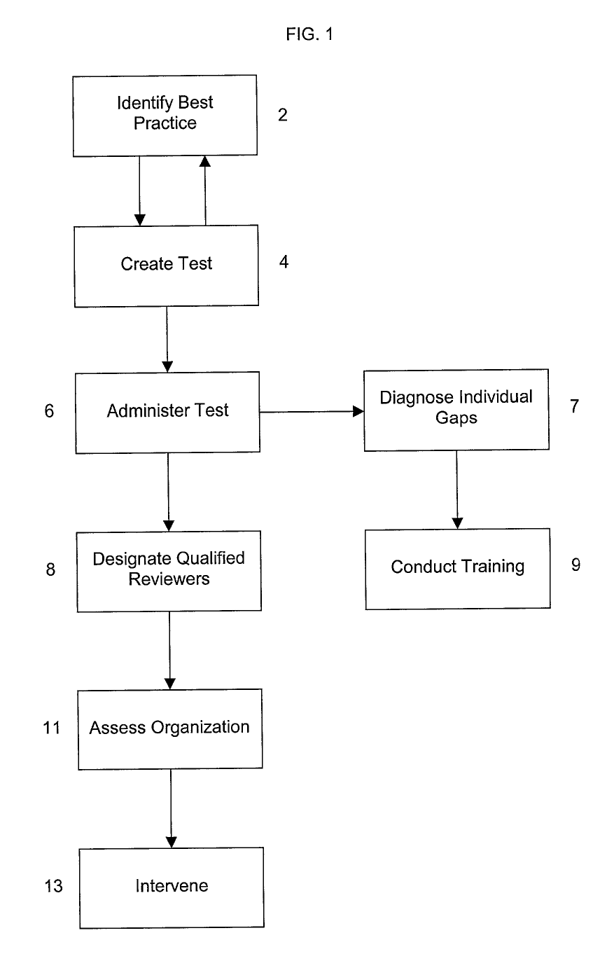

With reference to the drawings, in general, and FIGS. 1-7 in particular, the present invention is described.

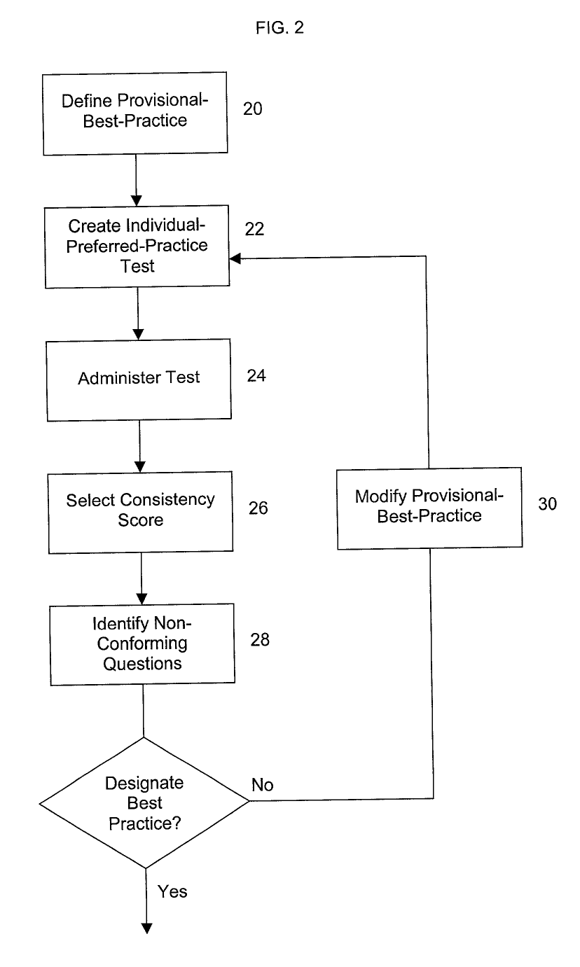

FIG. 1 depicts a preferred embodiment of a method of the present invention for assessing compliance with a best practice. As depicted in FIG. 1, a best practice for performing a task is identified in Identify Best Practice step 2. In the insurance industry, for example, the practice may pertain to a variety of tasks, such as making a sales call, underwriting a risk, or processing a claim, to name a few examples. Identify Best Practice step 2 may be accomplished in ways known to one of skill in the art, for example by reference to industry sources, company manuals or other reference materials, or through consultations with one or more experts. Identify Best Practice step 2 may also be accomplished though the steps identified in FIG. 2 or described in this specification or the claims.

In the preferred embodiment depicted in FIG. 2, after the relevant best practice is identified, a test for testing compliance with that best practice is created in Create Test step 4. The test is preferably designed to measure compliance by employees, field representatives or other workers with the best practice when performing the test. In preferred embodiments, the test would identify individual-preferred-practices for performing the task, which could be either how workers actually perform the task, or how workers think they should perform the task. Create Test step 4 can be created using conventional means known to those of skill in the art, or it could be created using some or all of the steps and methods described in this specification or the claims.

In the preferred embodiment depicted in FIG. 1, Identify Best Practice step 2 and Create Test step 4 may influence each other, so that the identification of the best practice and the creation of the test are iterative steps. For example, especially in cases where best practice requires some judgment about the particular circumstances, best practice may emerge as the result of an evaluation of practices in a variety of cases involving different circumstances. Thus, for example, a group of experts frequently can, if asked the right questions, develop best practices. The preferred embodiment depicted in FIG. 1 therefore contemplates an initial identification of a best practice, the creation of a proposed test for that best practice, and the application of the proposed test to representative case studies, with the initial best practice and the proposed test being refined as experts or others converge on the best practice for the particular task.

Once Create Test step 4 is accomplished, in the preferred embodiment depicted in FIG. 1, the next step in the method is Administer Test step 6. Preferably, in Administer Test step 6, the test is given to workers who perform the task. In preferred embodiments, the test is administered over an electronic telecommunications network, including the Internet or a local area or wide area network. In alternate embodiments, the test is administered to groups of people in person, or by mail, or by other conventional means. The test may be administered to some or all (or substantially all) of the workers who perform the test. In preferred embodiments, the test is administered to a sufficiently large portion of the workers who perform the task so that one or more statistically reliable indications can be provided of whether individual-preferred-practices for performing the task comport with the best practice.

As depicted in FIG. 1, in a preferred embodiment, two steps flow from Administer Test step 6: Diagnose Individual Gaps step 7 and Designate Qualified Reviewers step 8. In Diagnose Individual Gaps step 7, the gaps or deviations are assessed between the individual-preferred-practice of individual test takers and best practice. This may involve self-assessment, for example by providing test takers with preferred answers to the test questions they missed, or providing the rationale or reasons for the preferred answer or best practice in the context of the particular test question. Diagnose Gaps step 7 may also involve review of test-taker answers by supervisors or other evaluators.

In the preferred embodiment depicted in FIG. 1, after Diagnose Individual Gaps step 7, training of individual test takers is undertaken in Conduct Training step 9. In preferred embodiments, the training is responsive to the results of Diagnose Individual Gaps step 7 for the particular test taker. Thus, for example, it may be sufficient for the test taker to review the preferred answers and rationales or, depending on the nature and importance of the task, or the test taker's score, or both, for the test taker to undergo training, either on site or at special classes. Other training scenarios could be developed, depending on the circumstances, as would be apparent to a skilled trainer in the circumstances, given the identification of the best practice and the results of Diagnose Individual Gaps step 7. In preferred embodiments, employees who perform a task are trained in the best practice for that task by qualified reviewers. If the qualified reviewers and employees who perform the task are peers, or otherwise work for or are identified with the same organization, then increased interest among workers in implementing the best practice is expected.

In the preferred embodiment depicted in FIG. 1, also after Administer Test step 6, a group of test-takers is designated as qualified reviewers in Designate Qualified Reviewers step 8. A goal of this step is to select a group of people who will be responsible for reviewing actual practices of others for performing the task in order to assess their compliance with the best practice. In preferred embodiments, in Designate Qualified Reviewer step 8, a qualified reviewer is designated based on her test scores reflecting a predetermined level of consistency between her individual-preferred-practice and the best practice. In other preferred embodiments, a qualified reviewer is selected based on the level of his test score relative to the test scores of others, so that, regardless of absolute test scores, a fraction (e.g., the top decile) of test-takers will be designated as qualified reviewers. Other systems for designating qualified reviewers are apparent to those of skill in the art, depending on such factors as the task to be performed, the difficulty of the best practice, and the number of qualified reviewers needed.

In the preferred embodiment depicted in FIG. 1, in Assess Organization step 11, one or more of the qualified reviewers conducts a review of the actual practices of other individuals for performing the task. This review may be conducted by any number of means, such as observing the performance of the task, or reviewing files recording the performance of the task. In preferred embodiments, the designated reviewers and the individuals whose task performance is being reviewed are peers or otherwise work for or are affiliated with the same organization. In preferred embodiments, the task-performance of a sufficiently large number of individuals is reviewed to provide a statistically reliable sample, for example of how the task is actually performed in the field.

Assess Organization step 11 of the preferred embodiment depicted in FIG. 1 involves an analysis of the consistency of actual practices for performing the task with the best practice. This analysis would be responsive to the results of the review of actual practices, and could be accomplished using conventional analysis techniques, as well as consultations among the qualified reviewers.

In preferred embodiments not depicted in FIG. 1, the results of Assess Organization step 11 would be reported to management of the organization, for a variety of purposes, such as the development of incentives, broad-based training programs and strategic goals, for example. In the preferred embodiment depicted in FIG. 1, this is reflected in Intervene step 13. Significant deviations across an organization between individual-preferred-practice and best practice may suggest, for example, compensation incentives to prompt implementation of best practice, reorganization of offices or work flows, or that the task itself should be performed by specially-trained teams. Other examples of interventions at the organizational level would be apparent to those of management skill in the particular tasks or industry, depending on the nature of the task and the nature and extent of the deviations across the organization from best practice.

FIG. 2 depicts a preferred embodiment of the method of the present invention for determining or identifying a best practice for performing a task. The method illustrated in FIG. 2 may be practiced in conjunction with the method depicted in FIG. 1 for assessing compliance of actual practices with the best practice.

In the preferred embodiment depicted in FIG. 2, a provisional-best-practice is defined in Define Provisional-Best-Practice step 20. In some respects, the provisional-best-practice is a “seed” for the process. Thus, the provisional-best-practice may not yet be implemented, but rather may be proposed for implementation by management of an organization, by consultants or experts, or by workers themselves. In such embodiments, the provisional-best-practice is defined as a result of collaboration among members of a team designated for this purpose, and may include individuals with experience in performing the task, cost control, operations and other disciplines relevant to defining a provisional-best-practice. Alternatively, the provisional-best-practice may be, for purposes of the method of the present invention, a practice that is implemented or otherwise known as a best practice, and the method will assist in determining whether that best practice should be modified.

In the preferred embodiment depicted in FIG. 2, a test, comprising at least one test question and an answer corresponding to each test question is formulated in Create Individual-Preferred-Practice Test step 22. The purpose of the test is to develop information on individual-preferred-practice for performing the task that is the subject of the provisional-best-practice. The test can be developed using conventional techniques, or the steps described in this specification of the claims. In a preferred embodiment not specifically depicted in FIG. 2, the Create Individual-Preferred-Practice Test step 22 includes steps for “testing the test,” such as by administering the test to the members of the team that created the test, and then evaluating the results of that initial testing to help assure that the test serves its purposes, including identifying individual-preferred-practices in a manner that permits or facilitates an evaluation of the consistency of those practices with the best practice. As a further step, in preferred embodiments, the test may be modified in response to the initial administration of the test to members of the group and their responses. In essence, this aspect of a preferred embodiment includes an initial feedback loop to help improve the likelihood that the test will serve its intended purposes.

In Administer Test step 24 of the preferred embodiment depicted in FIG. 2, the test is administered to individuals who perform the task, but who are not members of the team that created the test. This step can be accomplished through electronic telecommunications, as described above, or through in-person or other means known to those of skill in the art.

In Select Consistency Score step 26 of the preferred embodiment depicted in FIG. 2, the score of each test taker is determined. In preferred embodiments, the score represents the degree of consistency between the individual-preferred-practice of the test-taker for performing the task, on the one hand, and the best practice for performing that task, on the other hand. In Select Consistency Score step 26, a score is selected reflecting a certain degree of consistency between individual-preferred-practice and the best practice. Looking ahead in the method of the present invention, the purpose is to designate a group of test takers whose scores indicate that their individual-preferred-practices comport with the best practice. In preferred embodiments, a predetermined proportion of the test takers achieve a score reflecting the selected degree of consistency. In further preferred embodiments, the predetermined proportion is less than 50%, so that the designated test takers represent the “better” performers of the task. In other preferred embodiments, the predetermined proportion is set to select a specified number, such as less than 100, of the test takers.

An important step in the preferred embodiment depicted in FIG. 2 takes place in Identify Non-Conforming Questions step 28. In this step, a comparison is made between the answers to test questions as initially formulated, on the one hand, and the answers to those questions by a predetermined proportion of test-takers whose scores, as discussed above, show general overall consistency between their individual-preferred-practices and the provisional best practice. In this Identify Non-Conforming Questions step 28, questions identified as non-conforming questions are preferably those for which a group of test-takers, with demonstrated capability to identify if not use the provisional-best-practice, still do not identify or use the provisional-best-practice.

For each such question, there should be a legitimate concern either that the test question should be modified better to elicit the provisional-best-practice as an answer, or that the provisional-best-practice should be modified. Accordingly, in the preferred embodiment depicted in FIG. 2, in the Designate Best Practice? decision step 30, the results of Identify Non-conforming Questions step 28, as well as other information relevant to the particular circumstances, such as the number of test-takers, the nature and complexity of the questions, and the number of other “non-conforming questions” related to the provisional-best-practice, is considered to determine whether the provisional-best-practice can be designated as the best practice.

If not, as depicted in the preferred embodiment of FIG. 2, the provisional-best-practice is modified in Modify Provisional Best Practice step 30, and a new test is created in Create Individual Preferred Practice Test step 22. In Modify Provisional Best Practice step 30, it may be sufficient to create new questions, or to modify questions from previous iterations in order to provide a satisfactory test. In this context, one way in which a test would be satisfactory is if the predetermined proportion of test-takers, whose test scores on the previous test represented at least the selected degree of consistency between individual-preferred-practice and the previous provisional-best-practice, also had test scores on the modified test reflecting at least that degree of consistency between individual-preferred-practice and the modified provisional-best-practice.

Other steps for checking or validating the provisional-best-practice include collecting comments from the test-takers, or from the test-takers with scores reflecting the selected degree of consistency between individual-preferred-practice and the provisional practice, about all of the questions, or about the questions identified in steps comparable to Identify Non-Conforming Questions step 28. The comments would then be evaluated and, in response to that evaluation, either test questions or the provisional-best-practice could be modified or confirmed as the best practice.

The present invention also contemplates other methods for identifying the best practice for performing a task. In a preferred embodiment (not depicted), a plurality of experts in performing the task is convened. As used in this context, the term “experts” broadly encompasses people with expertise or success, or both, in performing the task. In the insurance industry, for example, experts in sales could be salespeople with a certain level of tenure in the organization or industry, or could include people, whatever their level of experience, with the highest sales volumes in recent periods. Similarly, experts in claims processing could be people with significant experience, or with special expertise, or with records of low error rates with a recently-introduced procedure or system, for example.

In a preferred embodiment for identifying a best practice, the designated team of experts collaborate to develop a questionnaire concerning the performance of the task. The questionnaire could, for example, solicit information on how steps of the task are performed, or how they should be performed. Preferably, the questionnaire is geared to be answered as the steps of the task are undertaken.

In the further identification of a best practice, the questionnaire would be administered to the experts in the context of a case study involving the performance of the task. In this way, the questionnaire can be “tested” at least to give an idea of the likelihood that will elicit desired information concerning how the task is undertaken. The results of the test of the questionnaire would be evaluated and, in response to that evaluation and other relevant factors, the experts or others conducting the process, would converge on the best practice.

It is apparent that the steps described above for identifying a best practice could be applied equally to the identification of a provisional-best-practice for use in other methods of the present invention, including the method for assessing consistency between individual-preferred-performance and a best practice for performing a task.

The method of the present invention for evaluating consistency of individual-preferred-practice with best practice for performing a task can be generalized to the distributed calibration of a test for other purposes. In such a method, a test is created comprising at least one test question and a provisional-best-answer corresponding to each questions. This generalized step corresponds to the Create Test step 4 of FIG. 1. In the method of distributed calibration of a test, the next step is to administer the test to a plurality of test takers, which corresponds to the Administer Test step 6 of FIG. 1. The next step in the distributed test calibration is scoring the test, to determine the degree of consistency between the provisional-best-answers and the test-taker-answers. A predetermined group of test-takers is identified whose test scores represent at least a selected degree of consistency between provisional-best-answers and test-taker-answers. If the answers by members of that group to a question differs from the provisional-best-answer, then the provisional-best-answer or the question, or both, are evaluated. The next step is to decide, based on factors such as the number and complexity of the questions, or the number of questions where the test-taker answers disagreed with the provisional-best-answers, whether the provisional-best-answer can be designated as the best answer.

This more general method for distributed calibration of a test shares many features and implementation aspects of the methods described above. These include improving the test, for example by amending the provisional-best-answer to comport with the answers given by the group of test-takers whose scores otherwise show a high level of consistency between the test-taker answers and the provisional-best-answers. Alternatively, a question can be eliminated from the test if the provisional-best-answer disagrees with the test-taker answers by the group whose scores otherwise show a selected level of consistency between the provisional-best-answer and the test-taker answers. Other steps for improving the test include distributing the provisional-best-answers to test-takers, soliciting comments from the test-takers and the provisional-best-answers, evaluating those comments and deciding, in response, whether to modify the test, to modify a provisional-best-answer and re-test, or to designate a provisional-best-answer as the best answer.

As with other methods of the present invention, steps of the method for distributed test calibration can be implemented over the Internet or other electronic telecommunications network. Such steps include consultations to create the test, administration of the test, determination of the test scores, collecting test-taker comments, evaluating the questions and test-taker answers, and communicating results and analysis of the test and questions and answers. These steps can be conducted over the same or separate networks.

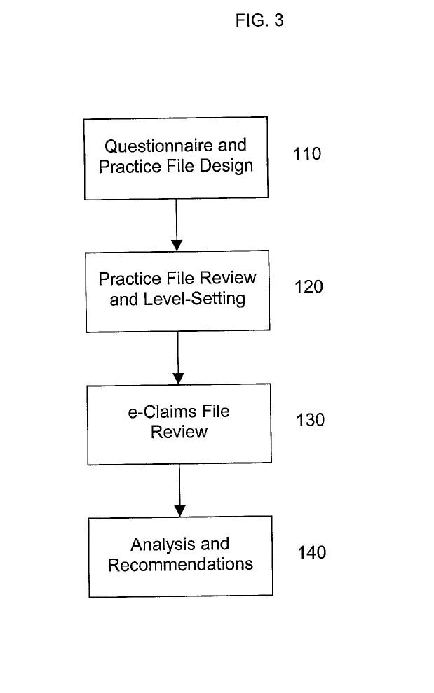

In a preferred embodiment in the insurance industry, the present invention is known as the Electronic Claims File Review, or e-CFR. In this embodiment, the present invention provides a novel approach to auditing field offices and training insurance field representatives. FIG. 3 illustrates a flow diagram of a preferred embodiment of a process of the present invention.

In step 110, the beginning of the e-CFR process, a group of designated team members, which may be known as a Core Team, formulates a series of issues and questions, compiling a questionnaire or test that addresses real-life issues that may arise during claims processing, underwriting or other matters. In a preferred embodiment, the test questions are designed to elicit the individual-preferred-practices of field representatives in performing various tasks associated with various matters, which may be the way that employees believe that a task should be performed or may be the way that employees actually perform the task.

In a preferred embodiment, the Core Team comprises employees or representatives with experience relevant to the subject matter. In the insurance industry, this could include experience in claims processing, claims disposition and adjudication, finance and marketing, for example. The Core Team then reviews a relatively small set of representative insurance claims cases (including such information as the claim made and its disposition) and determines provisional answers to the test questions concerning these representative cases.

In a preferred embodiment, each Core Team member participates in drafting the questions and answers. In alternate preferred embodiments, some but not all of the Core Team members participate in the preparation of the test. The preparation of the test may be performed at company headquarters or other suitable location, or may be performed through electronic telecommunications facilities.

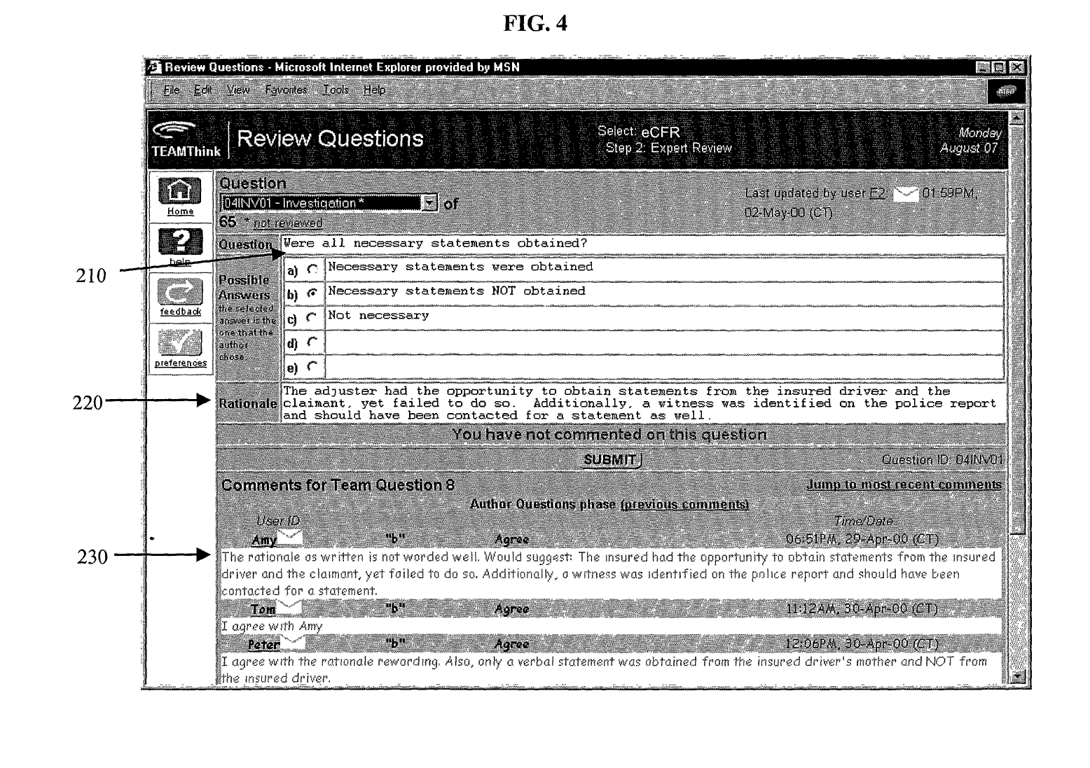

Referring to FIG. 4, in a preferred embodiment, questions and proposed answers are discussed among the members of the Core Team through the use of a computer program available at remote terminals. Core Team members may access the computer program through a private or public computer network, or on the Internet.

In preferred embodiments of the present invention, the computer program for use in formulating the questions and answers is a novel variation of software applications designed for collaborative learning in the education field and software produced by Athenium, Inc. Other comparable programs and systems as known in the art may also be used.

Using such computer programs, the Core Team members can participate in this phase of an e-CFR process from different locations, including for example, their own offices across the country. FIG. 4 illustrates a preferred embodiment of one aspect of the computer program in which the Core Team members collaborate on formulating test questions and answers. In a preferred embodiment of the present invention, the questions and answers 210 are in a multiple choice format in order to help standardize the questionnaire.

The Core Team may also develop a rationale 220 or reasons why the answer corresponding to a test question answer is preferred or considered to be correct. In a preferred embodiment, as part of the process, each team member gives feedback on existing test design and highlights issues for potential revision. In a preferred embodiment, team members can submit comments 230 to the questions and answers drafted by other team members through the use of the computer program. A preferred embodiment of the present invention thus provides an electronic format for interactive feedback on questionnaire design and for tracking the group's discussions.

In an example of a preferred embodiment of the present invention, the Core Team formulates questions and answers for five case files, or practice files, that are representative of the issues encountered by insurance field representatives in performing one or more tasks. A goal may be, for example, to design a questionnaire or test that can accurately measure inefficiencies that occur during claims processing by field representative and to determine the actions that are the source of the inefficiencies.

Once the design of test is completed, the tests, with their respective answer sets, can then be used in step 120 of the method illustrated in FIG. 3. Through this process, the Core Team is able to distribute expertise by an electronic means so that Core Team members are not required personally to review vast numbers of case files throughout the country.

In the preferred embodiment depicted in step 120 of FIG. 3, as part of the e-CFR process, claim representatives in the various offices around the country also review the same case studies that have been reviewed by the Core Team, and will complete the test. These representatives are selected to take the test because they perform the tasks that are the subject of the test and an effort to develop best practices for the tasks. In a preferred embodiment, after completing the test, claim representatives will be able to instantly see how their answers compare with the reflecting provisional-best-practices Core Team answers.

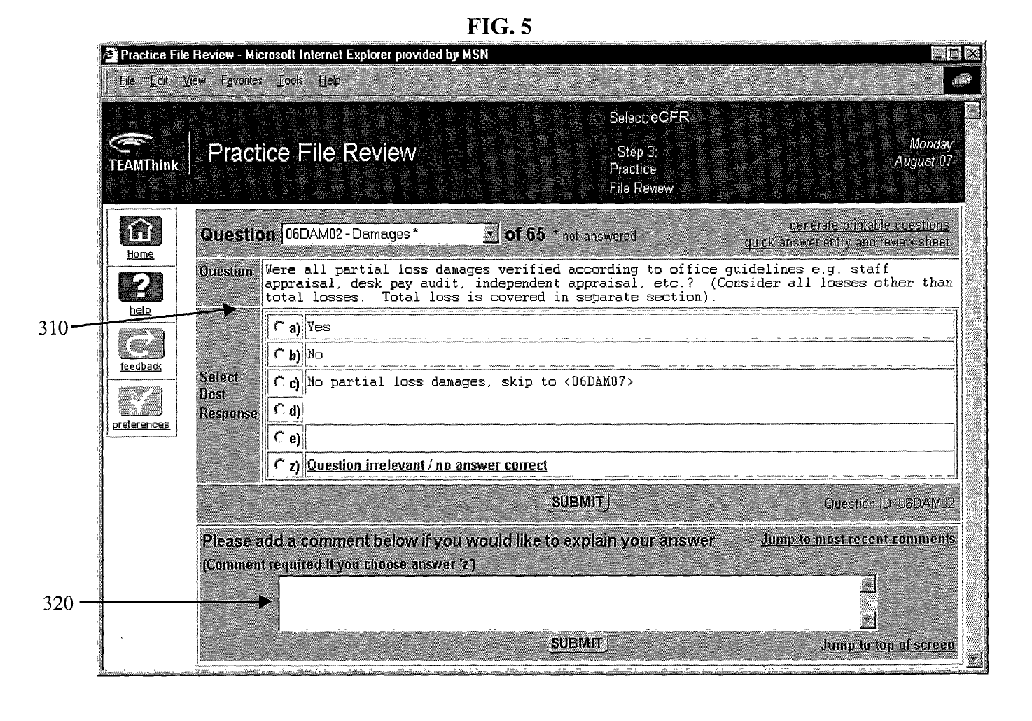

Referring to FIG. 5, in a preferred embodiment, the eCFR process uses software deployed on the Internet. Field representatives or other employees taking the test (or completing the questionnaire) review the same case files analyzed by the Core Team and answer the questions 310 developed by the Core Team. In a preferred embodiment, if a field representative disagrees with the answer choices available or how a question is worded, the representative can enter comments in box 320.

This testing process translates the Core Team's personal expertise into a question-and-answer set that is initially validated by the Core Team and may also be continuously updated through an iterative process in which claims representatives provide feedback, which the Core Team can then incorporate, in real-time if desired, into the active question-and-answer set. Thus the e-CFR implementation of the present invention does not require the Core Team to be in the same location for extended periods of time, the question-and-answer set can be accessed by many people at the same time, and the question-and-answer set can be subject to an ongoing, iterative process of real-time validation and updating.

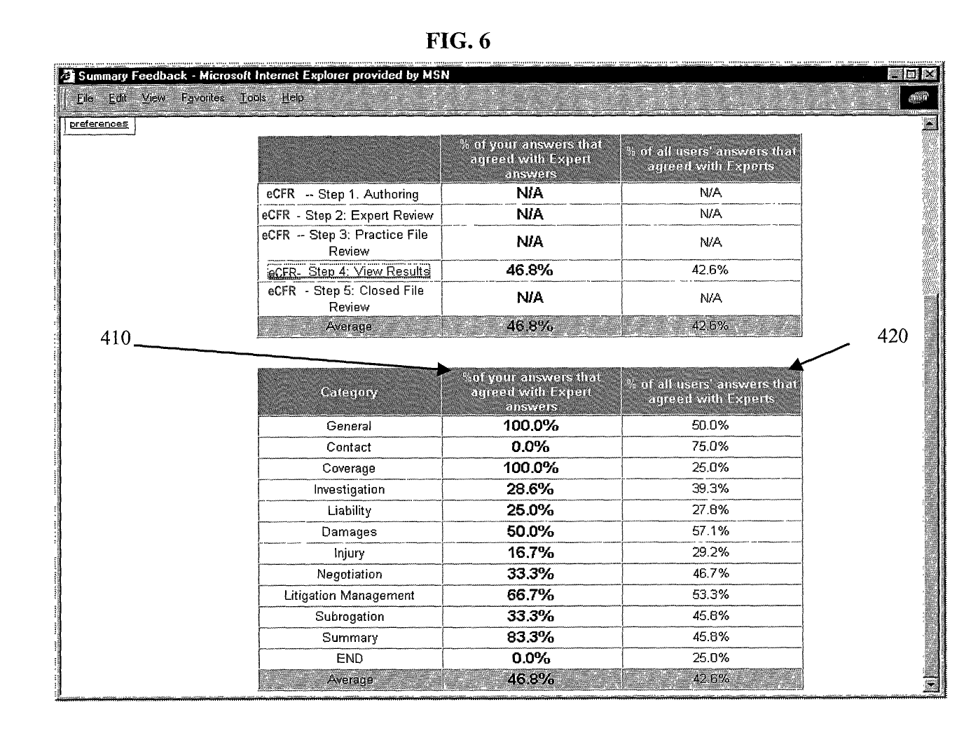

After a field representative or other employee has completed and submitted to answers to a questionnaire, her or his score is computed. This score represents the degree of consistency between the representative's individual-preferred-practice and the provisional-best-practice for the tasks that are the subject of the test. In a preferred embodiment, a computer program automatically calculates the score of correctly answered questions. FIG. 6 illustrates an embodiment of such a report generated by a computer program. In a preferred embodiment, for each category of questions, the report depicted in FIG. 6 shows in column 410 the percentage of questions answered correctly by the representative taking the test. Column 420 reports the average performance of all field representatives that have completed the test. It should be apparent to those skilled in the art that the computer program can generate a variety of reports and calculations based on all the answers submitted by the test takers.

The process of answering test questions designed to elicit individual-preferred-practices for daily activities of field representatives or other employees gives an organization the ability to identify superior representatives or other employees while expending reduced resources. In a preferred embodiment, the interactive aspect of the questionnaire results in a bottom-up, participative process that can capture the interest of test takers, and can evaluate field representatives or other employees, for example to determine those most qualified to evaluate the current practices of each field office within the organization.

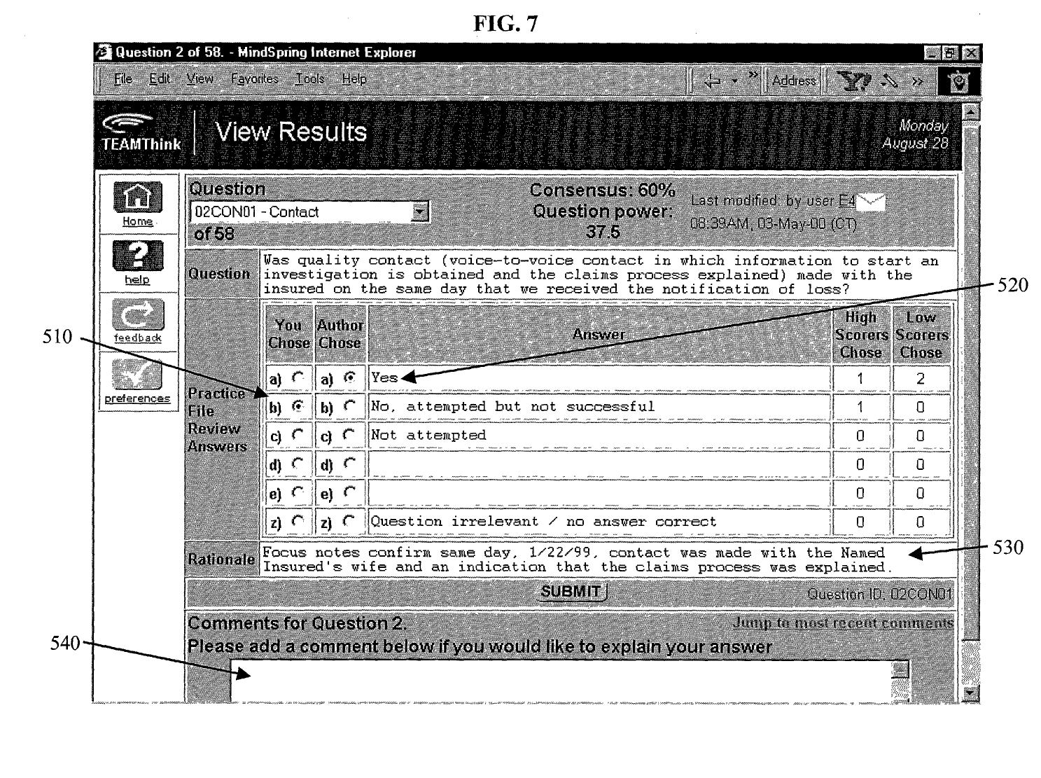

In another aspect of the present invention, after a field representative or other employee has completed a questionnaire or test, the employee can compare the answers submitted with the correct answers, as determined by the Core Team. Referring to FIG. 7, in a preferred embodiment, a computer program compares the field representative's answers 510 with the Core Team's answers 520. The program also discloses the rationale 530 or reason formulated by the Core Team why the Core Team's answer is preferred.

In a preferred embodiment, if a representative or other employee does not agree with the Core Team's rationale for an answer, the program permits the representative to enter a comment in box 540 that can be viewed by others using the program. In this manner, the Core Team monitors and reevaluates the questions and answers whenever a significant number of employees raises the same or similar problems or issues.

The method of the present invention provides other forms of feedback to improve the process and the best practice developed as a result of the process. For example, the test answers developed by the Core Team can be distributed to the test takers, preferably after the test takers themselves answer the applicable questions, and comments on the Core Team answers can be collected and evaluated. If appropriate, for example to remove ambiguities or to take account of factors not adequately considered by the Core Team, the test questions, corresponding test answers and/or provisional-best-practices can be modified.

As indicated above, the method for developing a best practice of the present invention can be implemented using electronic telecommunications, including computer communications networks such as the Internet or a local or wide area network. In a preferred embodiment, members of the Core Team use a first network to create the test. In an alternate preferred embodiment, the test is administered to test takers over a second network. In another alternate preferred embodiment, the first network and the second network are the same or share common facilities and services.

The present method also contemplates the use of the testing process as a way to prompt interest in implementing and using best practices, including by members of a distributed workforce. Thus, in addition to distributing the test corresponding answers, and test scores, to test takers, they can be asked to comment on the test and the corresponding answers. If appropriate, the test questions, corresponding answers or even the best practice can be modified in light of test-taker comments. Test-takers can also receive their re-determined scores in light of such modifications, again with the goal of generating and maintaining interest in the development and implementation of best practices for various tasks. These interactions can be implemented over computer communications networks.

The present invention also provides a novel method for training and screening field representatives or other employees working at different or distributed locations. The questions and answers of the test can be tools for performance-focused self-learning. In a preferred embodiment, during a representative's review of answers, the computer program contains links to available learning aides and reference materials, for example within the program or on the Internet, that explore in depth the issues tested by the question.

In the insurance industry, for example, the present invention can also be used to identify a group of field representatives who are qualified to perform the closed file review that was once performed by a handful of experts. Therefore, the test may also serve as an engine for disseminating expertise and qualifying other field representatives to be experts themselves. In this way the present invention can be used to raise skill levels within an organization and propagates the knowledge base of the most qualified personnel at all levels.

In addition, tests developed using the methods of the present invention may be used to train and screen for qualified field representatives or employees who themselves qualify to become trainers based on an iterative validation process. The qualified field representatives or employees may also be responsible for evaluating the practices of individual field offices or other individual representatives or employees. During this review, as illustrated in a preferred embodiment as step 130 in the preferred embodiment depicted in FIG. 3, the Core Team, as an additional calibration step, may spot check the work of the qualified representatives to ensure that the match between the patterns of responses by the selected representatives and the Core Team is sustained over time.

In step 140 of the preferred embodiment depicted in FIG. 6, the results of the e-CFR process by the selected employees are aggregated, and recommendations to address high-priority and/or high-opportunity problem areas are formulated and presented to management.

While there have been shown and described specific embodiments of the present invention, it should be apparent to those skilled in the art that various changes and modifications may be made without departing from the scope of the invention or its equivalents. The invention is intended to be broadly protected consistent with the spirit and scope of the appended claims.

What is claimed is:

1. A method of determining a best practice for performing a task, comprising:
defining a provisional-best-practice for performing the task based on collaboration among a plurality of designated team members;
creating a test for determining individual-preferred-practice for performing the task, the test comprising at least one test question and an answer corresponding to each test question;
administering the test to a plurality of test takers comprising individuals who perform the task but are not designated team members;
determining for each of the plurality of test takers a test score representing the degree of consistency between individual-preferred-practice and the provisional-best-practice;
identifying each test question for which the corresponding test answer disagrees with answers to that test question provided by a predetermined proportion of test takers whose test scores represent at least a selected degree of consistency between individual-preferred-practice and the provisional-best-practice; and
deciding, responsive to the identifying step, whether the provisional-best-practice can be designated as the best practice.

2. The method of claim 1, wherein the predetermined proportion is less than fifty percent.

3. The method of claim 1, wherein the predetermined proportion selects fewer than 100 test takers.

4. The method of claim 1, wherein the creating step comprises:
initially administering the test to the designated team members; and
evaluating the test responsive to the initially administering step.

5. The method of claim 4, wherein the creating step further comprises changing the test.

6. The method of claim 1, further comprising the steps of:
collecting comments concerning the test questions and corresponding answers identified in the identifying step; and
modifying the provisional-best-practice responsive to the collecting step.

7. The method of claim 1 wherein the administering step uses electronic telecommunications.

8. A method of determining a best practice for performing a task, comprising:
defining a provisional-best-practice for performing the task based on collaboration among a plurality of designated team members;
creating over a first network a test for determining individual-preferred-practice for performing the task, the test comprising at least one test question and an answer corresponding to each test question;
administering the test over a second network to a plurality of test takers comprising individuals who perform the task but are not designated team members;
determining for each of the plurality of test takers a test score representing the degree of consistency between individual-preferred-practice and the provisional-best-practice;
identifying each test question for which the corresponding test answer disagrees with answers to that test question provided by a predetermined proportion of test takers whose test scores represent at least a selected degree of consistency between individual-preferred-practice and the provisional-best-practice; and
deciding, responsive to the identifying step, whether the provisional-best-practice can be designated as the best practice.

9. A method of testing individuals who perform a task for consistency between individual-preferred-practice for performing the task and a best practice for performing the task, comprising:
creating a test for determining individual-preferred-practice for performing the task, the test comprising at least one test question and an answer corresponding to each test question;
administering the test to a plurality of test takers comprising individuals who perform the task;
determining for each of the plurality of test takers a test score representing the degree of consistency between individual-preferred-practice and the best practice;
identifying each test question for which the corresponding test answer disagrees with answers to that test question provided by a predetermined proportion of test takers whose test scores represent at least a selected degree of consistency between individual-preferred-practice and the best practice; and
modifying the test responsive to the identifying step.

10. The method of claim 9, wherein the predetermined proportion is less than fifty percent.

11. The method of claim 9, wherein the predetermined proportion selects fewer than 100 test takers.

12. The method of claim 9, wherein the creating step comprises:
initially administering the test to designated team members; and
evaluating the test responsive to the initially administering step.

13. The method of claim 12, wherein the creating step further comprises changing the test.

14. The method of claim 9, further comprising the steps of:
collecting comments concerning the test questions and corresponding answers identified in the identifying step; and
modifying the test responsive to the collecting step.

15. The method of claim 9, wherein the administering step uses electronic telecommunications.

16. A method of testing individuals who perform a task for consistency between individual-preferred-practice for performing the task and a best practice for performing the task, comprising:
creating over a first network a test for determining individual-preferred-practice for performing the task, the test comprising at least one test question and an answer corresponding to each test question;
administering the test over a second network to a plurality of test takers comprising individuals who perform the task;
determining for each of the plurality of test takers a test score representing the degree of consistency between individual-preferred-practice and the best practice;
identifying each test question for which the corresponding test answer disagrees with answers to that test question provided by a predetermined proportion of test takers whose test scores represent at least a selected degree of consistency between individual-preferred-practice and the best practice; and
modifying the test responsive to the identifying step.

17. The method of claim 9, wherein the modifying step comprises:
amending the answer corresponding to at least one of the test questions identified in the identifying step to reflect the most common answer, to that test question, by the predetermined proportion of test takers; and
re-determining, responsive to the amending step, the test score for each of the plurality of test takers.

18. The method of claim 17, wherein the modifying step further comprises:
communicating the modified answer to at least one of the test takers.

19. The method of claim 17, further comprising the step of implementing the best practice by communicating the modified answer to at least one of the test takers.

20. The method of claims 18 or 19, wherein the communicating step occurs over a network.

21. The method of claim 9 wherein the modifying step comprises:
eliminating from the test each question identified in the identifying step; and
re-determining, responsive to the eliminating step, the test score for each of the plurality of test takers.

22. The method of claim 21, wherein the modifying step further comprises:
communicating the eliminated question to at least one of the test takers.

23. The method of claim 21, further comprising the step of implementing the best practice by communicating the eliminated question to at least one of the test takers.

24. The method of claims 22 or 23, wherein the communicating step occurs over a network.

25. The method of claim 9, wherein the modifying step comprises:
collecting comments concerning the questions and corresponding answers from the predetermined proportion of test takers;
amending, responsive to the collecting step, the answer corresponding to at least one question identified in the identifying step;
re-determining, responsive to the amending step, the test score for each of the plurality of test takers.

26. The method of claim 25, wherein the amending step further comprises:
communicating to each test taker the collected comments.

27. The method of claim 25, further comprising the step of implementing the best practice by communicating the collected comments to at least one of the test takers.

28. The method of claims 26 or 27, wherein the communicating step occurs over a network.

29. A method of distributed calibration of a test, comprising:
creating a test, the test comprising at least one test question and a provisional-best-answer corresponding to each test question;
administering the test to a plurality of test takers;
determining for each of the plurality of test takers a test score representing the degree of consistency between provisional-best-answers and test-taker-answers;
identifying each test question for which the provisional-best-answer disagrees with the test-taker-answer provided by a predetermined proportion of test takers whose test scores represent at least a selected degree of overall consistency between provisional-best-answers and test-taker-answers; and
deciding, responsive to the identifying step, whether the provisional-best-answers can be designated as the best answers.

30. The method of claim 29, wherein the predetermined proportion is less than fifty percent.

31. The method of claim 29, wherein the predetermined proportion selects fewer than 100 test takers.

32. The method of claim 29, wherein the creating step comprises:
initially administering the test to designated team members; and
evaluating the test responsive to the initially administering step.

33. The method of claim 32, wherein the creating step further comprises changing the test.

34. The method of claim 29, further comprising the steps of:
collecting comments concerning the test questions and provisional-best-answers identified in the identifying step; and
modifying the test responsive to the collecting step.

35. The method of claim 29, wherein the administering step uses electronic telecommunications.

36. A method of distributed calibration of a test, comprising:
creating over a first network a test, the test comprising at least one test question and a provisional-best-answer corresponding to each test question;
administering the test over a second network to a plurality of test takers;
determining for each of the plurality of test takers a test score representing the degree of consistency between provisional-best-answers and test-taker-answers;
identifying each test question for which the provisional-best-answer disagrees with the test-taker-answer provided by a predetermined proportion of test takers whose test scores represent at least a selected degree of overall consistency between provisional-best-answers and test-taker-answers; and
deciding, responsive to the identifying step, whether the provisional-best-answers can be designated as the best answers.

37. The method of claim 29, wherein the deciding step comprises:
amending the provisional-best-answer corresponding to at least one of the test questions identified in the identifying step to reflect the most common answer, to that test question, by the predetermined proportion of test takers; and
deciding, responsive to the amending step, whether the amended provisional-best-answer can be designated as the best answer.

38. The method of claim 37, wherein the deciding step further comprises:
communicating the amended provisional-best-answer to at least one of the test takers.

39. The method of claim 38, wherein the communicating step occurs over a network.

40. The method of claim 29, wherein the deciding step comprises:
eliminating from the test each question identified in the identifying step; and
deciding, responsive to the eliminating step, whether the remaining provisional-best-answers can be designated the best answers.

41. The method of claim 40, wherein the deciding step further comprises:
communicating the eliminated question to at least one of the test takers.

42. The method of claim 41, wherein the communicating step occurs over a network.

43. The method of claim 29, wherein the deciding step comprises:
collecting comments concerning the test questions and corresponding answers from the predetermined proportion of test takers;
amending, responsive to the collecting step, the provisional-best-answer corresponding to at least one test question identified in the identifying step;
deciding, responsive to the amending step, whether the amended provisional-best-answer can be designated as the best answer.

44. The method of claim 43, wherein the amending step further comprises:
communicating to each test taker the collected comments.

45. The method of claim 44, wherein the communicating step occurs over a network.

46. A method for assessing compliance with a best practice for performing a task, comprising the steps of:
identifying the best practice;
creating a test to measure consistency between individual-preferred-practice for performing the task and the best practice;
administering the test to members of a group of individuals who perform the task;
designating, responsive to the administering step, at least one member of the group as a qualified reviewer,
conducting a review, by at least one qualified reviewer, of actual practices of other individuals for performing the task; and
analyzing, responsive to the review-conducting step, the consistency of the actual practices with the best practice.

47. The method of claim 46, wherein the identifying step comprises:
convening a plurality of experts in the performance of the task;
collaborating, among the experts, to develop a questionnaire concerning the performance of the task;
administering the questionnaire to the plurality of experts with respect to at least one case study involving performance of the task;
evaluating the results of the questionnaire-administering step; and
converging, responsive to the evaluating step, on the best practice.

48. The method of claims 46 or 47, wherein the review-conducting step comprises conducting a review, by at least one qualified reviewer, of actual practices, by other individuals employed by the same organization, for performing the task.

49. The method of claims 46 or 47, wherein the designating step comprises designating, responsive to the administering step, at least one member of the group as a qualified reviewer to review actual practices of a statistically significant sample of a relevant population of individuals who perform the task.

50. The method of claims 46 or 47, further comprising the steps of:
reporting the results of the analyzing step to management;
formulating programs to train individuals in performing the best practice; and
conducting training, by the qualified reviewers, of other individuals in use of the best practice.

51. A method for identifying the best practice for performing a task and measuring compliance with it, comprising the steps of:
developing a questionnaire to identify steps that are involved in performing the task;
administering the questionnaire to individuals who are experts in performing the task;
identifying, responsive to the questionnaire-administering step, a best practice for performing the task;
creating a test to measure consistency between individual-preferred-practice for performing the task and the best practice;
administering the test to a members of a group of individuals who perform the task;
designating, responsive to the administering step, at least one member of the group as a qualified reviewer,
conducting a review, by at least one qualified reviewer, of actual practices of other individuals for performing the task; and
analyzing, responsive to the review-conducting step, the consistency of the actual practices with the best practice.

52. A method of determining a best practice for performing a task, comprising:
convening a plurality of successful performers of the task;
collaborating, among the successful performers, to develop a questionnaire concerning steps taken in performing the task;
administering the questionnaire to the plurality of successful performers with respect to at least one case of actual practice involving performance of the task;
evaluating the results of the questionnaire-administering step; and
converging, responsive to the evaluating step, on the best practice.

53. The method of claim 52, wherein the collaborating step uses electronic telecommunications.

54. The method of claim 52, wherein the administering step uses electronic telecommunications.

55. A method of determining a best practice for performing a task, comprising:
convening a plurality of successful performers of the task;
collaborating, among the successful performers, over a network to develop a questionnaire concerning the steps taken in performing the task;
administering the questionnaire over a second network to the plurality of successful performers with respect to at least one case of actual practice involving performance of the task;
evaluating the results of the questionnaire-administering step; and
converging, responsive to the evaluating step, on the best practice.

56. The method of each of claims 1 through 8, wherein the task is an insurance claims-processing task.

57. The method of each of claims 1 through 8, wherein the task is an insurance underwriting task.

58. The method of each of claims 9 through 28, wherein the task is an insurance claims-processing task.

59. The method of each of claims 9 through 28, wherein the task is an insurance underwriting task.

60. The method of each of claims 29 through 45, wherein the test is a test of insurance claims-processing skills and the test takers are individuals who perform insurance claims-processing tasks.

61. The method of each of claims 29 through 45, wherein the test is a test of insurance underwriting skills and the test takers are individuals who perform insurance underwriting tasks.

62. The method of each of claims 46 through 55, wherein the task is an insurance claims-processing task.

63. The method of each of claims 46 through 55, wherein the task is an insurance underwriting task.
